(19) United States
(12) Patent Application Publication
(10) Pub. No.: US 2009/0166977 A1
(43) Pub. Date: Jul. 2, 2009

(54) Seal

(75) Inventors: Domimoque Lutaud, Orbigny Au Mont (FR); Marc Sitarz, Langres (FR)

Correspondence Address: HARNESS, DICKEY & PIERCE, P.L.C., P.O. BOX 828, BLOOMFIELD HILLS, MI, 48303, US

(73) Assignee: Carl Freudenberg KG, Weinheim (DE)

(21) Appl. No.: 12/308,650

(22) PCT Filed: Mar. 1, 2007
(86) PCT No.: PCT/EP2007/001750

§ 371 Date: Dec. 17, 2008

(51) Int. Cl. F16J 15/34

(52) U.S. Cl. 277/358; 277/407; 277/406

(57) ABSTRACT

A seal, comprising a sealing element and an L-shaped support body that has an annular element and a disc-shaped flange, wherein the flange has an end face on the side facing away from the element, and wherein the sealing element is located on the end face.

### FIELD

The present disclosure is directed to a seal, including a seal element and an L-shaped supporting body that has an annular element and a disc-shaped flange. The flange has an end face on the side facing away from the element.

### BACKGROUND

This section provides background information related to the present disclosure which is not necessarily prior art.

Seals of known art consist of a support body made of metal and a disc-shaped seating element made of PTFE. The sealing element is secured to the support body by means of an intermediate layer made of a polymer material. Seals of this kind thus consist of at least three materials. Moreover the sealing element is configured such that the support body and also the contact face to which the sealing element with the intermediate layer is connected, as a result of which production is resource intensive. In certain configurations the medium that is being sealed can make contact with the support body or the contact face. This is then a problem, if the medium that is being sealed is chemically aggressive. Moreover seals of this kind are resource-intensive to produce.

### SUMMARY

This section provides a general summary of the disclosure, and is not a comprehensive disclosure of its full scope or all of its features.

The present disclosure provides a seal that is particularly easy to produce.

The sealing element may be located on an end face of a support body. The connection of the sealing element to the support body is made without an intermediate layer, so that an additional injection molding process may be eliminated.

In this manner, production is particularly simple and cost-effective. Moreover, the end face points in the direction of the space to be sealed. The sealing element may then located such that the side of the support body facing towards the space to be sealed is covered. Since only the sealing element forms a bounding surface with the space to be sealed, the medium to be sealed makes contact only with the sealing element. The sealing element protects the support ring and also the contact face between the sealing element and the support body from contact with the medium to be sealed.

The sealing element may be connected by means of material bonding with the support body. Material bonded connections are easily produced and require only a small design resource.

An adhesive layer may be present between sealing element and support body. The adhesive layer may be applied to either the bearing ring or the support ring. The adhesive joint may then be produced by application of pressure, with or without application of heat.

The sealing element may be located on the support body such that a first section of the sealing element forms a dynamic sealing lip and a second section of the sealing element forms a static seal. Here, the sealing element, surrounds the support body such that after assembly the first section of the sealing element surrounds the shaft to be sealed and the second section provides the static seal between the housing and support body. Here, it is particularly advantageous that by means of the sealing element the configuration of the static seal location between the housing and support body is fixed. In this manner, the joint between the support body and sealing element may be selected such that a trouble-free assembly is possible. The loadings occurring in operation are accommodated by a clamped joint of a sealing element between support ring and housing, and the sealing element is fixed in its location.

The sealing element may have a coating in the area of the second section. This coating may, for example, be a sealant. With small coating thicknesses these types of coatings improve the static sealing effect of the sealing element.

The sealing element may consist of a PTFE compound, which may also be reinforced with glass fibers. Moreover, the use of a non-woven or felt material impregnated with a PTFE dispersion may be used. PTFE is insensitive to a large number of chemically aggressive media and has a small friction coefficient. Since the section of the sealing element forming the static seal is formed from PTFE the press-fitting of the seal into the housing to be sealed is simplified.

The support body may consist of a metallic material. Metallic materials are easy to form, so that support rings may be produced cost-effectively as stamped parts. The support body may also consist of plastic. Here, for example, complicated geometries may be produced by means of injection molding.

The sealing element may have scavenge grooves. The scavenge groove is configured in the area of the first section and with correct assembly points in the direction of the shaft to be sealed. The scavenge groove improves the dynamic sealing effect.

The sealing element may bulge out in a direction of the ambient environment. Seals of this kind are simple to assemble. No special assembly tools are required.

The sealing element may bulge out in a direction of the space to be sealed. Seals of this kind seal reliably, even at high pressures within the space to be sealed.

The present disclosure enables use of the same support body and the same disc-shaped sealing element for seals with sealing lips in both directions. It is only necessary to arrange the scavenge grooves of the sealing element on the support body so that they show towards the machine part (e.g. a shaft) that should be sealed.

The support body may comprise a holding device for a sensor. The holding device may be arranged on the annular element on the free end. The holding device and the support body are formed as a one-piece part. The holding device comprises a spacer and a connecting member for fixing a sensor. The outcome is a sealing arrangement comprising a seal and a sensor with only a few parts. Namely, a support body, a disc-shaped sealing element, and a sensor.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

Examples of the seal in accordance with the present disclosure are described in more detail with the aid of the figures. Thus, schematically in each case:

FIG. 1 shows the seal in accordance with a principle of the present disclosure;

FIG. 2 shows an assembled seal with a sealing lip extended in the direction of the ambient environment;

FIG. 3 shows an assembled seal with a sealing lip extended in the direction of the space to be sealed;

FIG. 4 shows a production procedure for the seal;

FIG. 5 shows a sealing arrangement with the seal and a sensor.

Corresponding reference numerals indicate corresponding parts throughout the several views of the drawings.

### DETAILED DESCRIPTION

Example embodiments will now be described more fully with reference to the accompanying drawings.

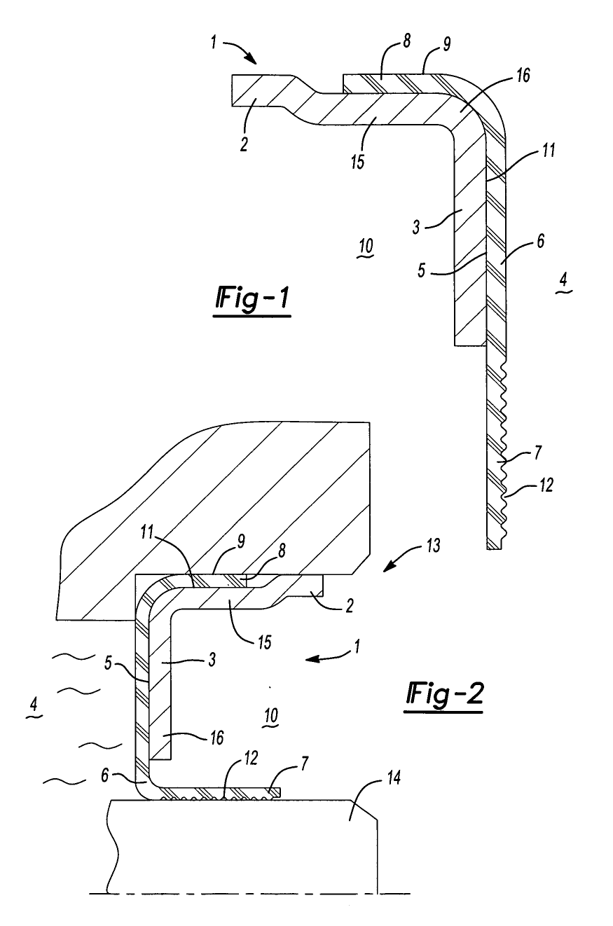

FIG. 1 shows a seal 1, including a support body 2 made of a metallic material and a sealing element 6 made of a glass fiber-reinforced PTFE compound. The L-shaped support body has an annular element 15 and a disc-shaped flange 16. The flange 16 has an end face 5 on a side facing away from the element 15. The sealing element 6 may be materially bonded by means of an adhesive joint to the end face 5 of the support body 2. Here, an adhesive layer 11 is present on the support body 2. The sealing element 6 may be located on the support body 2 such that a first section 7 of the sealing element 6 forms a dynamic sealing lip and a second section 8 of the sealing element 6 forms a static seal. For improvement of the static sealing effect, the sealing element 6 may have a coating 9 in the form of a sealant in the area of the second section 8. In the area of the first section 7, the sealing element 6 may have a scavenge geometry 12 in the form of scavenge grooves.

FIG. 2 shows a seal configuration 13 with a seal 1, in accordance with FIG. 1. The first section 7 of the sealing element 6 lies on the shaft 14 to be sealed, such that the sealing element 6 bulges out in the direction of the ambient environment 10. Here the end face 5 points in the direction of the space to be sealed 4 and the sealing element 6 is located such that the end face 5 of the support body 2 that is facing towards the space 4 to be sealed is covered, with only the sealing element 6 forming a bounding surface with the space 4 to be sealed.

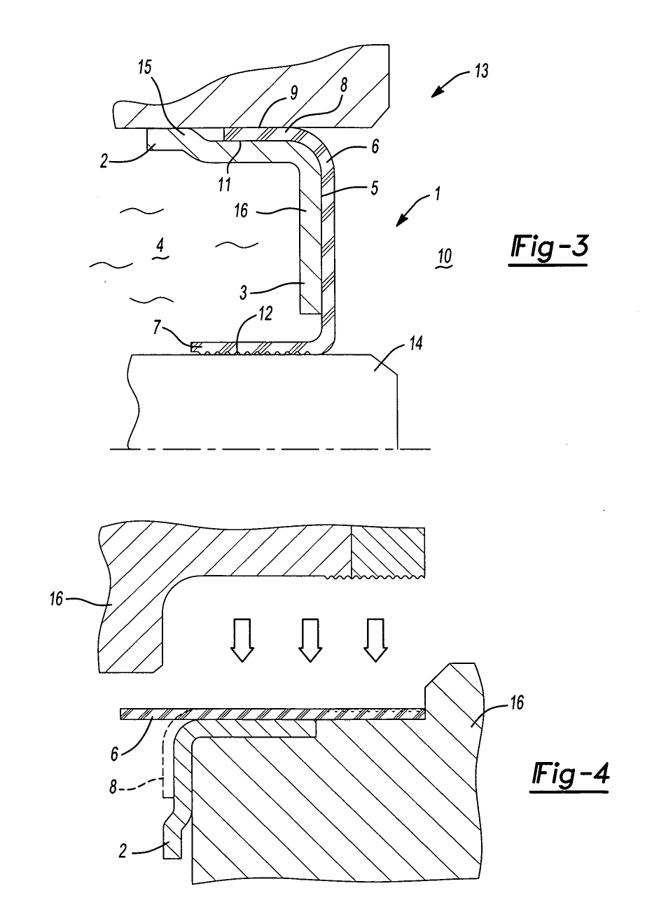

FIG. 3 shows a seal configuration 13 with a seal 1, in accordance with FIG. 1. The first section 7 of the sealing element 6 lies on the shaft 14 to be sealed, such that the sealing element 6 bulges out in the direction of the space to be sealed 4.

FIG. 4 shows the production procedure for the seal 1. A pre-formed support body 2 is placed in a mold 16 and a blank of a sealing element 6 is located on the end face 5 of the support body 2. The support body 2 has an adhesive layer 11. Next, by the simultaneous application of pressure and stamping, the sealing element 6 is materially bonded with the support body 2 and the scavenge geometry 12 is introduced into the first section 7 of the sealing element 6. The application of pressure may take place with or without the application of heat.

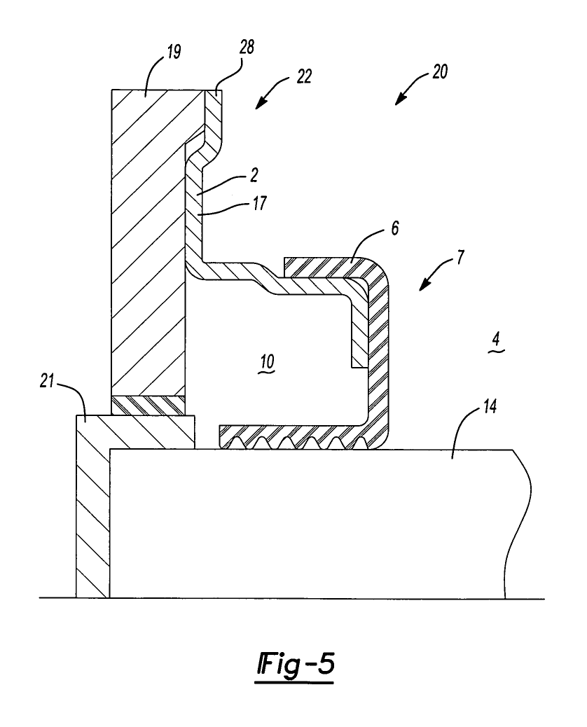

FIG. 5 shows a sealing arrangement 20 with a seal 1 in accordance with FIG. 1. The support body 2 further includes a holding device 22, whereby the holding device 22 includes a spacer 17 and a connecting member 18 for detachably fixing a sensor 19. The sensor 19 may be fixed in the connecting member 18 by a snap fit. The sensor 19 may be fixed by a screw fitting or by an adhesive joint. The encoder 21, which is detected by the sensor 19, is mounted on the shaft 14 which is sealed by the sealing element 6.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

1.-12. (canceled)

13. A seal, comprising: a sealing element; and
an L-shaped support body that has an annular element and a disc shaped flange,
wherein the flange has an end face on the side facing away from the element, wherein the sealing element is located on the end face.

14. The seal according to claim 13, wherein the end face points in a direction of a space to be sealed, the sealing element being configured such that the face of the support body that is facing towards the space to be sealed is covered.

15. The seal according to claim 13, wherein only the sealing element forms a bounding surface with the space to be sealed.

16. The seal according to claim 13, wherein the sealing element is materially bonded with the support body.

17. The seal according to claim 13, wherein an adhesive layer is located between support body and sealing element.

18. The seal according to claim 13, wherein the sealing element is located on the support body such that a first section of the sealing element forms a dynamic sealing lip and a second section of the sealing element forms a static seal.

19. The seal according to claim 13, wherein the sealing element has a coating in the area of the second section.

20. The seal according to claim 13, wherein the sealing element consists of a PTFE compound.

21. The seal according to claim 13, wherein the support body consists of a metallic material.

22. The seal according to claim 13, wherein the sealing element bulges out in a direction of the ambient environment.

23. The seal according to claim 13, wherein the sealing element bulges out in a direction of a space to be sealed.

24. The seal according to claim 13, wherein the support body comprises a holding device for a sensor.
